(19) United States
(12) Patent Application Publication
(10) Pub. No.: US 2014/0144965 A1
(43) Pub. Date: May 29, 2014

(54) METHOD TO MANIPULATE BRITTLE MATERIAL SHEET COMPOUND SHAPE

(71) Applicants: James William Brown, Painted Post, NY (US); Nicholas Dominic Cavallaro, III, Corning, NY (US); Ting-Jung Chia, Tainan City (TW); Keith Mitchell Hill, Horseheads, NY (US); Chih-Hung Lee, Taichung City (TW); Naiyue Zhou, Painted Post, NY (US)

(72) Inventors: James William Brown, Painted Post, NY (US); Nicholas Dominic Cavallaro, III, Corning, NY (US); Ting-Jung Chia, Tainan City (TW); Keith Mitchell Hill, Horseheads, NY (US); Chih-Hung Lee, Taichung City (TW); Naiyue Zhou, Painted Post, NY (US)

(21) Appl. No.: 13/688,293

(22) Filed: Nov. 29, 2012

(51) Int. Cl. C03B 33/02

(52) U.S. Cl. CPC C03B 33/02
USPC 225/2

(57) ABSTRACT

A method for manipulating a glass sheet compound shape during a severing operation including, for example, positioning a scoring device against the first side of the central portion of the glass sheet, and temporarily bending an extended portion of the glass sheet located between the scoring device and a selected one of the edge portions from a first orientation to a severing orientation by applying a force to the extended portion of the glass sheet. In one example, the force can be applied to achieve a predetermined surface stress in the glass sheet. The method can further include forming a score line along the first side of the central portion of the glass sheet while the force is being applied to the extended portion, and breaking away the selected one of the edge portions from the glass sheet along the score line.

### FIELD

The present disclosure relates generally to methods of manipulating a brittle material sheet compound shape, and more particularly, to methods for manipulating a brittle material sheet compound shape during a severing operation.

### BACKGROUND

Producing flat product glass for displays, such as LCDs, involves many challenges. A significant aspect in this process is an ability to produce a very consistent shape in large product glass plates. Typical large product glass sheets can be, for example up to 3.3 square meters.

Corning Incorporated has developed a process known as the fusion process (e.g., downdraw process) to form high quality thin glass sheets that can be used in a variety of devices like flat panel displays. The fusion process is a preferred technique for producing glass sheets used in flat panel displays because the product sheets have surfaces with superior flatness and smoothness when compared to glass sheets produced by other methods. The general fusion process is described in, for example, U.S. Pat. Nos. 3,338,696 and 3,682,609.

One embodiment of the fusion process involves using a fusion draw machine (FDM) to form a glass sheet and then draw the glass sheet between two rolls to stretch the glass sheet to a desired thickness. A traveling anvil machine (TAM) is used to cut the glass sheet into smaller glass sheets requested by customers.

Residual product stress and shape can be caused in the glass sheet by a number of factors, such as the process temperature profile, the glass ribbon motion caused by the TAM, and glass cutting. There are a number problems that can occur in the manufacture of liquid crystal displays whenever the residual stress of glass sheet is large or its shape is not stable.

### SUMMARY

The following summary provides a basic understanding of some example aspects described in the detailed description.

In one example aspect, a method to manipulate a glass sheet compound shape during a severing operation is provided. The method comprises providing the glass sheet having a pair of opposed edge portions and a central portion laterally spanning between the opposed edge portions. The central portion has a first side facing a first direction and a second side facing a second direction opposite the first direction. The method further comprises the steps of positioning a scoring device against the first side of the central portion of the glass sheet, and temporarily bending an extended portion of the glass sheet located between the scoring device and a selected one of the edge portions from a first orientation to a severing orientation by applying a force to the extended portion of the glass sheet. The method further comprises forming a score line along the first side of the central portion of the glass sheet while the force is being applied to the extended portion of the glass sheet, and breaking away the selected one of the edge portions from the glass sheet along the score line

In another example aspect, a method to manipulate a glass sheet compound shape during a severing operation is provided. The method comprises providing the glass sheet having a pair of opposed edge portions and a central portion laterally spanning between the opposed edge portions. The central portion has a first side facing a first direction and a second side facing a second direction opposite the first direction. The method can further comprise positioning a scoring device against the first side of the central portion of the glass sheet, and applying a force to an extended portion of the glass sheet located between the scoring device and a selected one of the edge portions sufficient to achieve a predetermined surface stress along the first side of the glass sheet adjacent the scoring device. The method can further comprise forming a score line along the first side of the central portion of the glass sheet while the force is being applied to the extended portion of the glass sheet, and breaking away the selected one of the edge portions from the glass sheet along the score line.

In yet another example aspect, a method to manipulate a glass sheet compound shape during a severing operation is provided. The method comprises providing the glass sheet with a pair of opposed edge portions and a central portion laterally spanning between the opposed edge portions. The central portion has a first side facing a first direction and a second side facing a second direction opposite the first direction. The method can further comprise positioning a scoring device against the first side of the central portion of the glass sheet, and sensing a first orientation of an extended portion of the glass sheet located between the scoring device and a selected one of the edge portions. The method can further comprise determining an amount of a force to be applied to the extended portion of the glass sheet sufficient to achieve a predetermined severing orientation, based upon a comparison of the sensed first orientation and the predetermined severing orientation. The method can further comprise applying the force to the extended portion of the glass sheet to temporarily bend the extended portion of the glass sheet to achieve the predetermined severing orientation, and forming a score line along the first side of the central portion of the glass sheet while the force is being applied to the extended portion of the glass sheet, and breaking away the selected one of the edge portions from the glass sheet along the score line.

### BRIEF DESCRIPTION OF THE DRAWINGS

These and other features, aspects and advantages of the present disclosure are better understood when the detailed description is read with reference to the accompanying drawings:

FIG. 1 schematically illustrates an example apparatus for manipulating a glass sheet;

FIG. 2 schematically illustrates a graph of the results of one example experiment;

FIG. 3 is similar to FIG. 1, but shows another condition of the example apparatus for manipulating a glass sheet;

FIG. 4 schematically illustrates a graph of the results of another example experiment;

FIG. 5 schematically illustrates one example configuration of a manipulation device;

FIG. 6 schematically illustrates another example configuration of the manipulation device;

FIG. 7 schematically illustrates one example configuration of the manipulation device on an example VBS machine;

FIGS. 8A-8D schematically illustrate various example initial incoming and resulting glass shapes; and

FIG. 9 schematically illustrates a graph of the results of yet another example experiment.

### DETAILED DESCRIPTION

Methods will now be described more fully with reference to the accompanying drawings in which example embodiments of the disclosure are shown. Whenever possible, the same reference numerals are used throughout the drawings to refer to the same or like parts. However, this disclosure may be embodied in many different forms and should not be construed as limited to the embodiments set forth herein.

Recent trends in the LCD glass manufacture have been to progressively wider size and more recently a move to thinner glass sheets, such as about 0.3 mm (i.e., 300 microns) thickness or less. Both of these trends (wider and thinner) significantly reduce the inherent stiffness of the glass sheet and make the production process more sensitive at the Bottom of Draw (BOD). This sensitivity is primarily driven by the non-planarity of the glass sheet. This shape is primarily driven by the thin center portion of the glass sheet cooling much more rapidly than the thicker bead edge regions. Consequently, a thermal mismatch results in a vertical and/or horizontal bow being induced into the glass sheet as a result of internal stresses that cause the glass sheet to distort into a non-symmetric compound shape (e.g., a “potato chip” type shape). This can create many problems in sheet glass processing such as breakage and transport instability.

One aspect discussed herein is the management of this compound shape during the glass cutting (e.g., severing) process. Another aspect discussed herein relates to a method of manipulating the sheet shape on thin glass such that the resulting surface stress in the glass is advantageous to the score and break separation process. Manipulation of the glass sheet towards a predetermined shape, in conjunction with the scoring wheel and breaking mechanism, work to remove the outer bead portion of the sheet within a machine designed to do the same, referred to as a Vertical Bead Scoring machine (VBS). A thin glass sheet, such as 0.3 mm thickness, develops the described compound shape as the sheet is conveyed from the FDM (Fusion Draw Machine) to the VBS prior to sheet edge bead removal.

Generally, one goal when scoring thin glass sheet for edge bead removal is to produce a uniform median vent simultaneously on both sides of the VBS (e.g., on both of the inlet and compression sides). A general rule is for the score vent depth to be normally about 10% of the glass thickness. If a sheet is flat and the surface stress is controlled, the median crack depth can be relatively easily controlled by applying a stable scoring force to the score wheel. However, when scoring on thin glass with unpredictable shape, the vent depth cannot be controlled using standard methods due to the glass shape inducing either or both of compressive and tensile stresses on the glass surface during a single scoring event. This change in stress results in a highly variable median crack, normally resulting in sheet breakage.

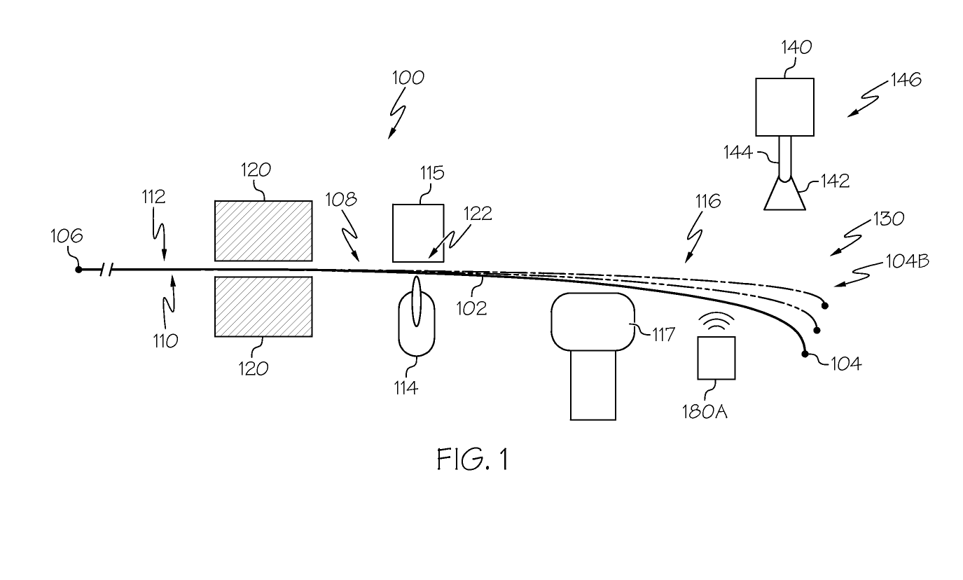

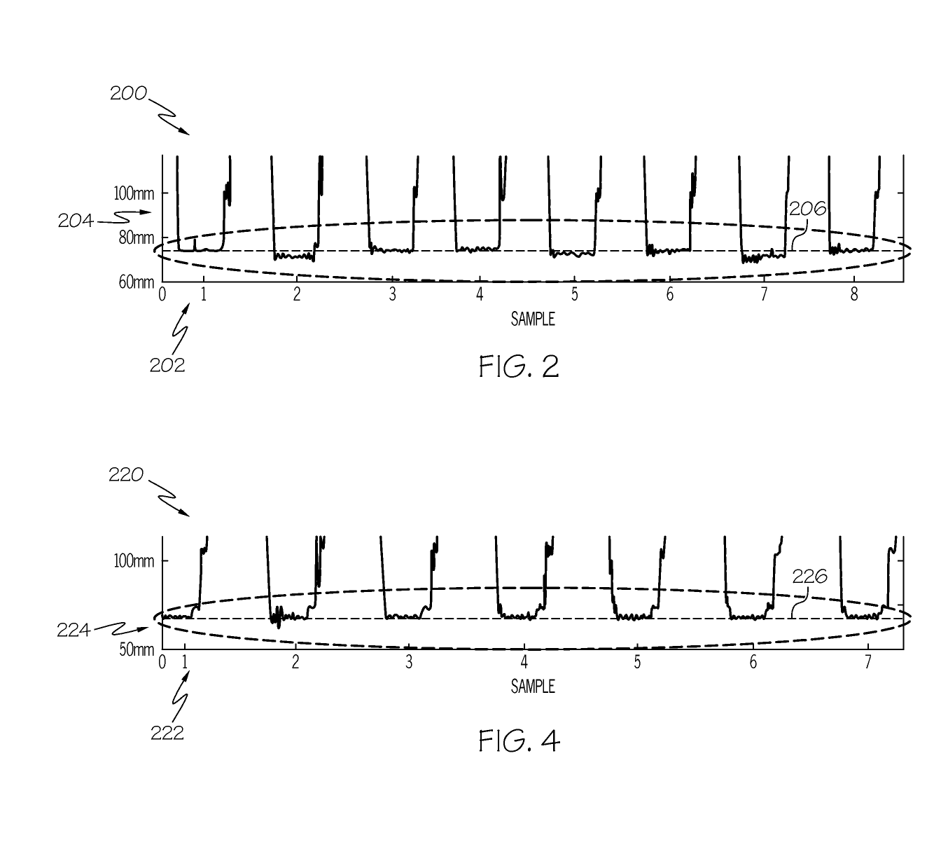

FIGS. 1-2 illustrate one example apparatus 100 for manipulating a glass sheet 102 compound shape during a severing operation. As discussed more fully herein, the glass sheet 102 can be at least partially severed to provide a glass product suitable for use in various display devices. The glass sheet 102 can comprise glass suitable for a liquid crystal display, OLED, components of a photovoltaic device such as solar cells, photovoltaic arrays, and like applications. In this example, the glass sheet 102 has been previously separated from a glass ribbon. However, it is contemplated that the structure and methodology discussed herein can be used with a glass ribbon. The glass sheet 102 generally comprises a pair of opposed edge portions 104, 106 and a central portion 108 of the glass sheet 102 laterally spanning between the opposed edge portions 104, 106. The central portion 108 has a first side 110 facing a first direction and a second side 112 facing a second direction opposite the first direction. The first and second sides 110, 112 are identified for convenience, and are not intended as a limitation.

Each of the opposed edge portions 104, 106 terminates at an enlarged bead area that is beneficial to remove (e.g., sever) from the glass sheet 102. Although the following discussion focuses on one selected edge portion 104, it is contemplated that the structure and methodology can be similarly applied to various other portions of the glass sheet 102, such as the other edge portion 106. The severing process can incorporate a wide range of techniques. For example, the edge portion 104 can be severed from the central portion 108 by way of a glass cutting device, such as a scoring device 114. The scoring device 114 can be positioned against the first side 110 of the central portion 108 of the glass sheet 102.

For example, the scoring device 114 can be, for example, a scribe or other mechanical device that can create an initial defect (e.g., crack, scratch, chip, or other defect) with the point of the scribe to create a controlled surface defect at the site where the glass sheet 102 is to be severed. The scoring device 114 can include a tip although an edge blade or other scribe technique may be used in further examples. Still further, the initial defect or other surface imperfection may be formed by etching, laser impact, or other techniques. The initial defect may be created at the edge of the glass sheet 102 or at an inboard location on the surface of the glass sheet 102. An active or passive nosing device 115 can be used on the other side of the glass sheet 102 opposite to the scoring device 114 to inhibit glass sheet motion transferred from the scoring or breaking process. A side push break assembly 117 is located near the scoring device 114 to facilitate the glass breaking process to remove the edge portion 104. The side break assembly 117 is located between the scoring device 114 and the edge portion 104, and can be positioned on either the first or second side 110, 112 of the glass sheet 102.

The central portion 108 of the glass sheet 102 may be clamped at a distance away from the edge 104 and generally near the scoring device 114 to facilitate the scoring process by stabilizing the glass sheet 102. In one example, the central portion 108 may be clamped by a tower clamp 120 located inboard of the scoring device 114. An extended portion 116 of the glass sheet 102 is then defined between the scoring device 114 and the edge portion 104. The extended portion 116 acts as a cantilever due to the tower clamp 120. Thus, because of the tower clamp 120, the extended portion 116 of the glass sheet 102 may still be vertically movable relative to the scoring device 114, which can cause a variable distance gap 122 between the glass surface to be scored and the scoring device 114, nosing device 115, or both.

For example, as illustrated schematically in FIG. 1 in phantom lines, the position of the edge portion 104B is unstable and inconsistent during the cutting process when constrained only by the tower clamp 120. Turning briefly to FIG. 2, a graph 200 shows the results of an experiment measuring the position of the edge portion 104B relative to a fixed point on the apparatus 100. The x-axis 202 indicates eight example glass sheets that were cut using the structure of FIG. 1, while the y-axis 204 indicates the measured distance of the edge portion 104B for each glass sheet. Line 206 shows a predetermined distance of the edge portion 104B that results in a desirable score line on the glass. As can be readily seen, the distance of the edge portion 104B among the eight sample glass sheets was highly variable, which caused variable surface stress and vibrations in the first side 110 of each sample glass sheet. The variable surface stress and vibrations ultimately resulted in a highly variable median crack among the eight sample glass sheets, causing sheet breakage and lower yields.

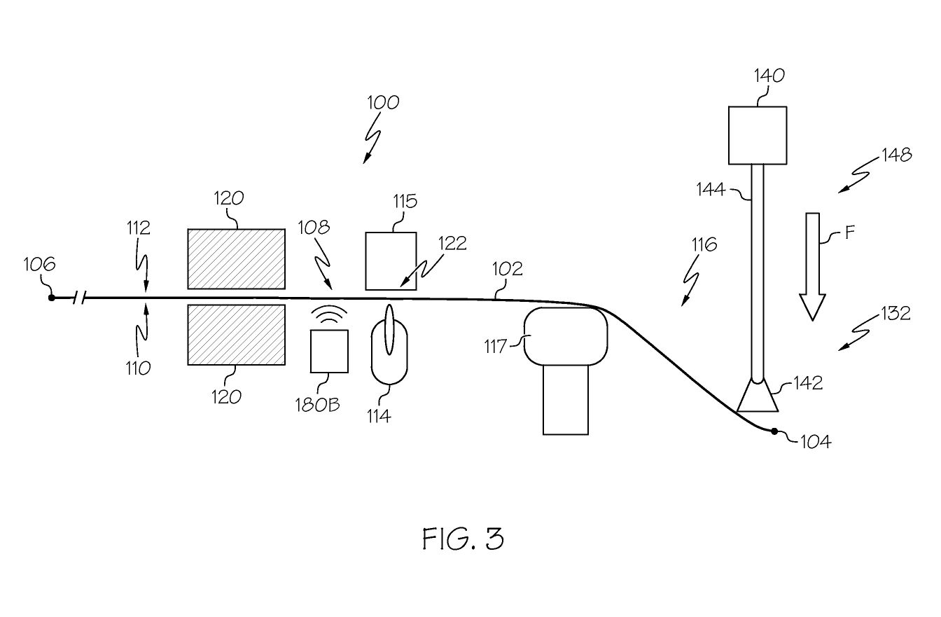

Turning now to the example shown in FIG. 3, an example apparatus 100 for manipulating the glass sheet 102 to alleviate the inconsistent position of the edge portion 104 will be discussed. To facilitate the description, the glass sheet 102 is positioned in the scoring device 114 against the first side 110 of the central portion 108 of the glass sheet 102. The extended portion 116 of the glass sheet 102 is still defined between the scoring device 114 and the edge portion 104.

The apparatus 100 can be used to temporarily bend the extended portion 116 of the glass sheet 102 from a first orientation 130 (FIG. 1) to a severing orientation 132 (FIG. 3) by applying a force F to the extended portion 116 of the glass sheet 102. Temporarily bending the extended portion 116 of the glass sheet 102 can help stabilize the glass sheet 102 during the eventual glass scoring and breaking operations. Such stabilization can help prevent buckling or disturbing the glass sheet 102 profile during the procedure of severing the edge portion 104. Moreover, the stabilization combats inconsistent surface stresses on the glass surface by mechanically redistributing the glass sheet shape adjacent the scoring device 114 to a generally neutral (e.g., flat) plane that allows a constant stress to be generated along the score line. Stated another way, a sufficient amount of force F can be applied to the extended portion 116 of the glass sheet 102 to achieve a predetermined surface stress along the first side 110 of the glass sheet 102 adjacent the scoring device 114. As a result, manipulation of the extended portion 116 thereby alters the surface stress of the glass sheet 102 to provide a relatively continual tension stress that reduces bead vibration and position variability to stabilize the thin glass sheet adjacent the scoring device 114 and reduce, such as prevent, premature or uncontrolled crack propagation. Generally, the force F is contemplated to be, for example, from about 1 to 10 pounds, and preferably about 3 to 5 pounds, although various other amounts of greater or lesser force are possible.

Turning briefly to FIG. 4, graph 220 shows the results of an experiment measuring the position of the edge portion 104 relative to a fixed point on the apparatus 100. The x-axis 222 indicates eight example glass sheets that were cut using the setup of FIG. 3, while the y-axis 224 indicates the measured distance of the edge portion 104 for each glass sheet. Line 226 shows a desired or predetermined distance of the edge portion 104 that results in a desirable score line on the glass. As can be readily seen, the distance of the edge portion 104 among the eight sample glass sheets was highly consistent, which provided consistent surface stress and greatly reduced vibrations in the first side 110 of each sample glass sheet. The consistent surface stress and reduced vibrations ultimately resulted in a highly consistent median crack among the eight sample glass sheets, providing clean and accurate glass severing and higher product yields.

Returning to FIG. 3, the device for applying the force F to the extended portion 116 of the glass sheet 102 can comprise a wide range of structures having various configurations. In embodiments, a manipulation device 140 can be used to temporarily bend the extended portion 116 from a first orientation to a severing orientation by applying the force F. The example manipulation device 140 can include a pusher-type device configured to push against the first or second side 110, 112 of the glass sheet 102 to apply the force F to the extended portion 116. As illustrated, the manipulation device 140 can be configured to push against the second side 112 of the extended portion 116 to manipulate the glass and provide a desirable position for the scoring process. In embodiments, the manipulation device 140 can also pull on the first or second side 110, 112 of the glass sheet 102 to apply the force F, such as via suction, a vacuum system, or the like.

In embodiments, the manipulation device 140 can include an extendable element 144 that is movable towards and away from the extended portion 116 of the glass sheet 102. Although it is contemplated that the extendable element 144 can be moved towards and away from the extended portion 116 along one or more various axes, the extendable element 144 described herein is movable generally along an axis perpendicular to the second side 112 of the glass sheet 102. Although only a single manipulation device 140 is shown, it is contemplated that multiple manipulation devices 140, multiple extendable elements 144, or both, can be utilized to bend the extended portion 116 to a predetermined severing orientation, to achieve a predetermined surface stress along the first side 110 of the glass sheet 102, or both.

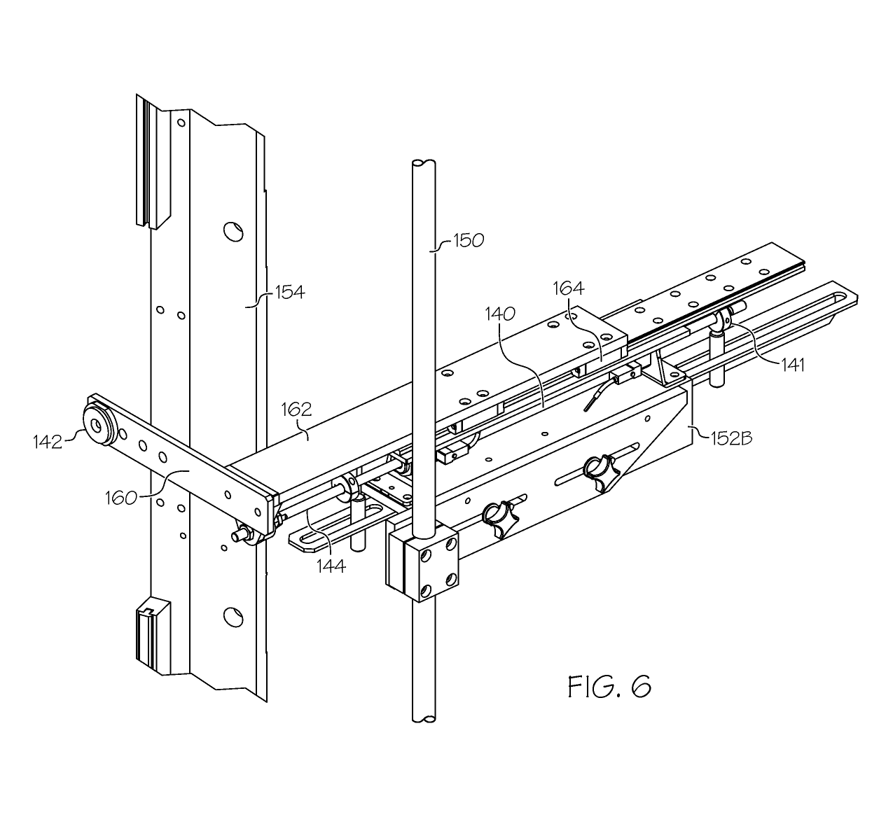

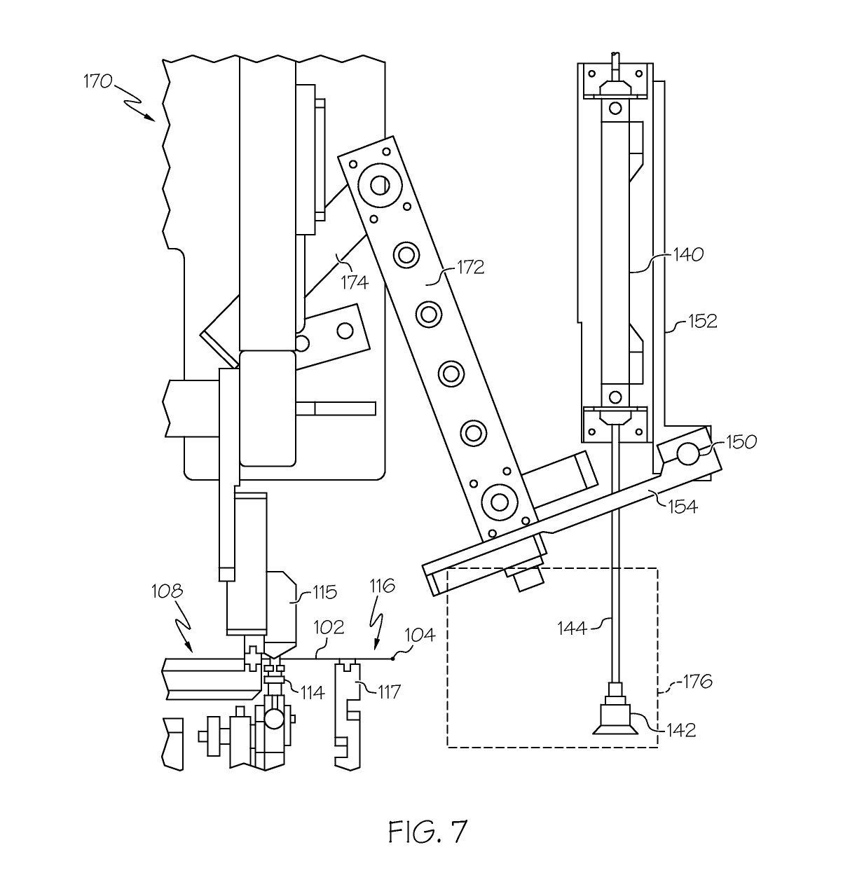

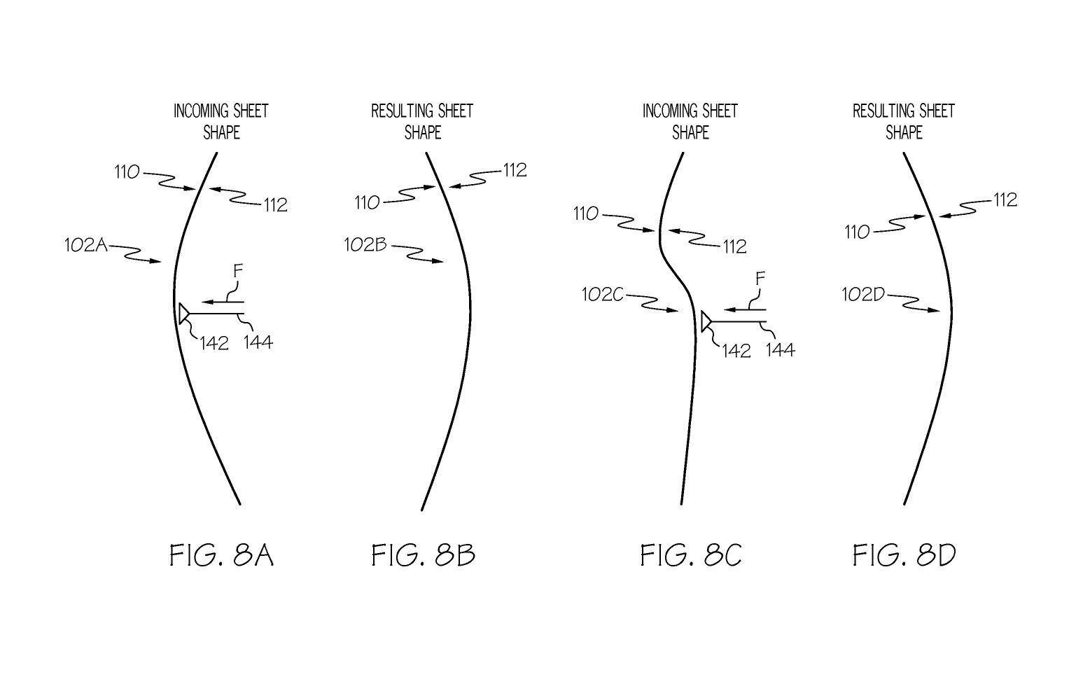

The manipulation device 140 can include various configurations for operating the extendable element 144 relative to the glass sheet 102, such as a linear motor, motorized threaded screw assembly, pneumatic or hydraulic cylinder, or similarly functioning devices. In the illustrated example, the manipulation device 140 includes a pneumatic cylinder, such as a constant force air cylinder that can accommodate various glass profiles and can apply a generally uniform contact force F to the glass. Pressure to the air cylinder controls the velocity of the extendable element 144, and adjustable mechanical stops 141 (see FIG. 6) can control the stroke length. The velocity and stroke length permit the extendable element 144 to manipulate the extended portion 116 to reduce, such as eliminate, the compound glass shape to control median crack depth and quality, and in turn, control the scoring and breakage performance. The velocity and stroke length can each be selectively adjusted manually or via automated control, such as via a programmable logic controller (PLC).

The manipulation device 140 can further include a tip 142 at a distal end of the extendable element 144 that is configured to contact and push against the second side 110 of the extended portion 116. The extendable element 144 is illustrated in a retracted position 146 in FIG. 1, in which the tip 142 is spaced a relatively large distance away from the extended portion 116, and in an extended position 148 in FIG. 3, in which the tip 142 is relatively close to or in contact with the extended portion 116 of the glass sheet 102. The tip 142 can include various configurations, a protective layer, or both, that will resist scratching or damaging the glass surface, such as a rubber tip, a ruby tip, a ceramic tip, a paper tip, etc. In embodiments, the tip 142 material can be resilient, such as rubber or silicone, although a non-resilient material (e.g., ruby or ceramic) can be provided on a resilient element, such as a spring. In still further examples, the tip 142 can be designed avoid trapping glass particles that can subsequently scratch the glass. Additionally, the tip 142 can have various geometries. In embodiments, as illustrated, the tip 142 can have a generally conical geometry, such as a relatively flexible “suction-cup” geometry. The “suction-cup” geometry can be used to provide a relatively larger surface area for distributing the force F onto the glass sheet, and not generally for attachment. Thus, modifications can be made to inhibit attachment of the tip 142 to the glass sheet. Still, the “suction-cup” geometry can be used for attachment to the glass sheet where a pulling-direction force F is desired. Still, the tip 142 can have various other geometries.

The location of the tip 142 on the glass, relative to the location of the desired score line, can influence the quality of the removed edge portion 104. For example, if the tip 142 is too close to the score line, it can create a mechanical stress field much like a “bulls-eye” due to the localized glass sheet deformation. Conventionally, this localized deformation did not affect scoring quality on the thicker glass due the inherent glass sheet stiffness. However, on relatively thin glass sheets (e.g., 0.3 mm or less) that exhibit relatively low sheet stiffness, this “bulls-eye” deformation becomes more pronounced. If this deformed region extends into the score line, the resulting high stress region can pull the score line away from its intended path and create glass breakage due to inconsistent median crack formation. Without a controlled median crack depth, scoring defects and breakage are more likely to occur. Thus, adjusting the position of the tip 142 and the force F application location can provide a beneficial variable for controlling the shape of the glass sheet and in turn median crack formation and stability.

In embodiments, the manipulation device 140 can be mounted on a conventional VBS tower assembly, such as on a conventional VBS breaker wing area, and used in conjunction with a conventional push break system for removal of the edge portion 104. When the extendable element 144 is in the extended position 148 and the tip 142 is in contact with the extended portion 116 of the glass, the force F, in conjunction with the push break fulcrum of the VBS machine, provides a load force to the glass sheet 102 that reduces, such as eliminates, the gap 122 on the side of the glass sheet 102 adjacent the scoring device 114, the nosing device 115, or both.

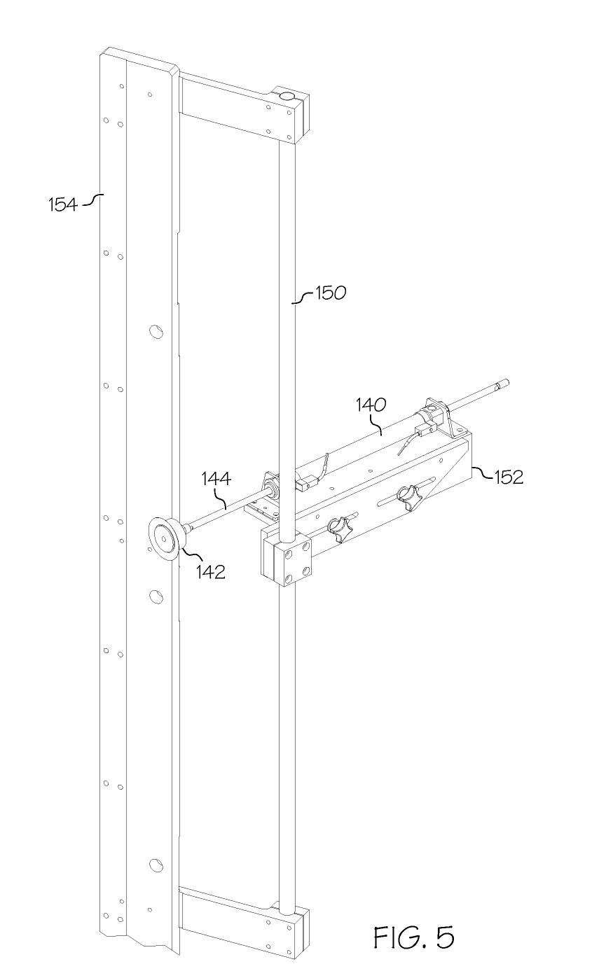

Turning to FIG. 5, one example configuration of the manipulation device 140 is shown. Generally, it is preferable to apply the force F towards the center of the extended portion 116. However, it may be desirable to alter the position of the force F. The manipulation device 140, including the pneumatic cylinder and extendable element 144, can be provided on a slide 150 via a carrier 152 that is configured to be selectively movable along the slide 150. The carrier 152 can be manually or automatically movable (e.g., screw drive, linear motor, pneumatic or hydraulic actuator, manual set screw, and like mechanisms) along the slide 150 to position the tip 142 at various locations along the extended portion 116 of the glass sheet 102. The carrier 152 is a generally rigid element that is configured to clamp or otherwise maintain a secured position on the slide 150 during application of the force F to the glass. The slide 150 can be located on the breaking wings of both the inlet and compression sides of the VBS machine via a mounting plate 154. Further, the slide 150 can be configured for use with glass sheets having extended portions 116 with various lengths. For example, the configuration illustrated in FIG. 5 can be usable with glass sheets having a relatively wide extended portion 116. As illustrated in FIG. 6, the slide 150 may alternatively be configured for use with glass sheets having a relatively narrow extended portion 116. For example, an offset adapter 160 could be coupled to the extendable element 144 to position the tip 142 at an offset position with respect to the mounting plate 154. A stabilization bar 162, which can extend together with the extendable element 144, can be coupled to the offset adapter 160. The stabilization bar 162 can be coupled to the carrier 152B (or even to the slide 150) via a bracket 164. In addition or alternatively, multiple manipulation devices 140 can be provided on the slide 150, and multiple slides can be used each with one or more manipulation devices 140.

Turning briefly to FIG. 7, one example configuration of the slide 150 is shown mounted to the breaking wing 172 of the VBS machine 170. While the manipulation device 140 may be movable along the slide 150, the mounting plate 154 carrying the slide 150 can itself be movable to alter the location of the force F application on the glass sheet 102. For example, the mounting plate 154 can be coupled to the breaking wing 172, which can form a mechanical two-bar arrangement with a movable member 174 that can have various configurations. Alternatively, the mounting plate 154 can be coupled to the VBS machine 170 in various other manners. Thus, the movable member 174 can permit the mounting plate 154 to move towards or away from the scoring device 114 to thereby provide the tip 142 of the extendable element 144 an example range of motion 176 illustrated in phantom lines. It is understood that the range of motion is further adjustable along the third axis into-and-out-of the page due to the slide 150. As a result, the manipulation device 140 can be usable with glass sheets 102 having a wide range of sizes.

Turning back to the illustrated example of FIG. 3, glass sheet 102 is pressed by the tip 142 from the second side 112 and against the side push break assembly 117. During the scoring process, the side push break assembly 117 provides stiffness on the opposite, first side 110 to allow the manipulation device 140 to change the shape of the still connected edge portion 104 to enable a successful score for the entire length of the glass sheet 102. In addition or alternatively, the side break assembly 117 can act as a bending fulcrum to leverage the edge portion 104 and facilitate the stabilization of the glass sheet 102. In addition or alternatively, the side break assembly 117 may be stationary or may even be movable along multiple axes, such as towards or away from the scoring device 114 (e.g., horizontally movable), the extended portion 116 (e.g., vertically movable), or both.

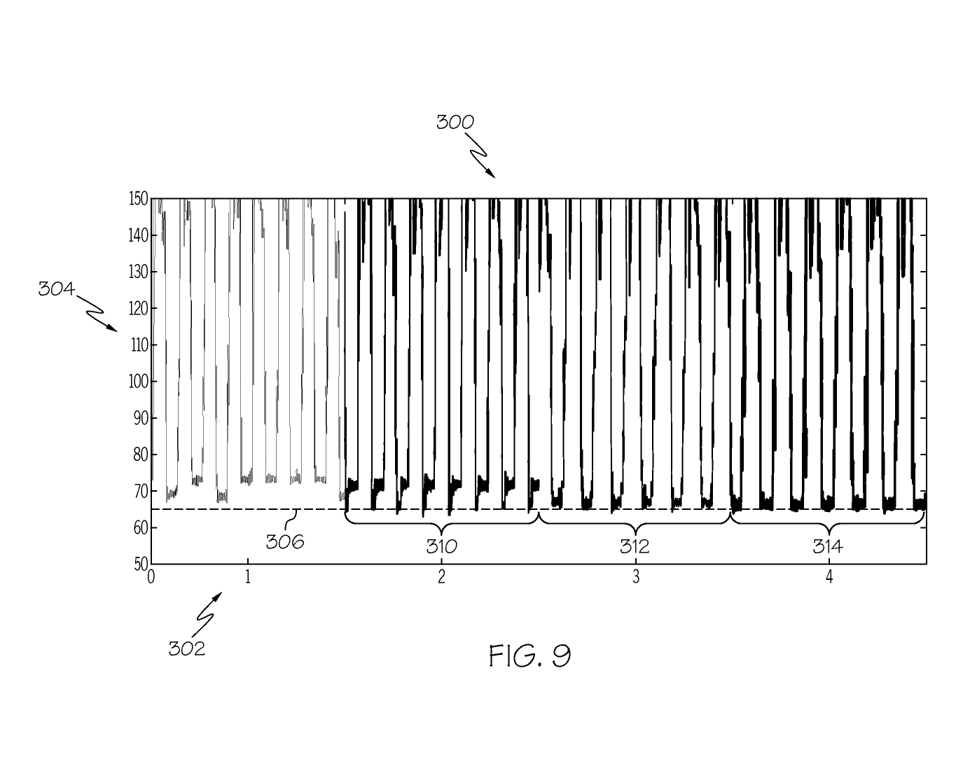

Using the structure and methods described herein, increased stabilization and rigidity of the extended portion 116 of the glass sheet 102 can be achieved by bending the extended portion 116 to induce an upwardly convex surface, an upwardly concave surface, or both along a direction arranged generally transverse to the direction of the force F. However, due to the temperature differential along the length of the glass sheet due to the manufacturing process, and due to either or both of the tower clamp 120 and the use of the push break assembly 117 as a fulcrum, the glass sheet 102 may exhibit a “bow pop” situation where the original direction of the glass sheet 102 changes direction or shape (e.g., convex to concave, or vice-versa). The “bow pop” behavior is counter-intuitive. For example, turning briefly for FIGS. 8A-8D, two examples of this behavior are illustrated. As shown in FIG. 8A, the glass sheet 102A has a concave shape as viewed from the second side 112. Upon applying the force F to the second side 112, the combined effect of the temperature differential of the cooling glass and partial restraint of the glass will cause the “bow pop” behavior resulting in the glass sheet 102B of FIG. 8B to have a convex shape as viewed from the second side 112. Similarly, as shown in FIG. 8C, the glass sheet 102C can have a mixed shape that is partially concave and partially convex as viewed from the second side 112. Upon applying the force F to the second side 112, the temperature differential of the cooling and partially restrained glass will cause the “bow pop” behavior resulting in the glass sheet 102D of FIG. 8D to have a convex shape as viewed from the second side 112.

As a result, by inducing a predetermined concave or convex geometry, the edge portion 104 can be stabilized while the glass scoring occurs to enable the scoring device 114 to encounter a stable, predetermined, or both, surface stress field that stabilizes the vent depth and inhibits, such as prevents, premature score crack propagation. The terms concave and convex are used for convenience, and that the “bow pop” behavior can be induced in other directions. Furthermore, although FIGS. 8A-8D represent simplified illustrations, the glass sheet 102 can have numerous internal stresses that cause the glass sheet to distort into a non-symmetric compound shape (e.g., a “potato chip” type shape) that can similarly be corrected by leveraging the “bow pop” behavior across one or more axes. In addition or alternatively, the location of the manipulation device 140 can be adjusted, as disclosed herein, to achieve the desired glass sheet geometry, surface stress, or both.

An example method to manipulate a glass sheet compound shape during a severing operation using the aforedescribed apparatus 100 will now be described with reference to FIGS. 1 and 3. The severing operation can be used, for example, to sever the edge portion 104 from the central portion 108 of a glass sheet 102. The method can include the step of positioning a scoring device 114 against the first side 110 of the central portion 108 of the glass sheet 102. Optionally, the method can include the step of positioning a nosing device 115 on the other side 112 of the glass sheet 102 opposite to the scoring device 114. An extended portion 116 of the glass sheet 102 can be located between the scoring device 114 and the edge portion 104. Optionally, the method can include the step of a positioning a push break assembly 117 as a fulcrum against the first side 110 of the glass sheet 102 at a location between the scoring device 114 and the edge portion 104.

The method can further include the step of temporarily bending the extended portion 116 from first orientation 130 to a severing orientation 132 by applying a force F to the extended portion 116 of the glass sheet 102. In embodiments, as shown in FIG. 3, the extended portion of the glass sheet 102 can be temporarily bent in a direction toward the first side 110 of the glass sheet 102. The force F can be applied until either or both of the extended portion 116 and the portion of the glass located between the scoring device 114 and the side push break assembly 117 achieve the predetermined severing orientation 132. In addition or alternatively, the force F can be applied until either or both of the extended portion 116 and the portion of the glass located between the scoring device 114 and the side push break assembly 117 achieve a predetermined surface stress along the first side 110 of the glass sheet 102 adjacent the scoring device 114. In embodiments, the force F can be applied until the predetermined surface stress is substantially constant along the first side 110 of the glass sheet 102 adjacent the scoring device 114.

Optionally, the method can further include, for example, the step of adjusting an amount, a the position, or both, of the force F (e.g., a position of the tip 142 of the extendable element 144), such as along the slide 150, to achieve either or both of the severing orientation of the glass sheet 102 and the predetermined surface stress along the first side 110 of the glass sheet 102. Optionally, the method can further include, for example, the step of applying multiple forces using multiple manipulation devices, adjusting the location, adjusting the force, or both, of the multiple manipulation devices.

Thereafter, the method can further include, for example, the steps of forming a score line along the first side 110 of the central portion 108 of the glass sheet 102 while the force F is being applied to the extended portion 116 of the glass sheet 102, and subsequently breaking away the edge portion 104 from the glass sheet 102 using the side push break assembly 117. Once scoring is complete, extendable element 144 is moved to the retracted position 146 so that the glass sheet 102 can be removed from the VBS machine. Extendable element 144 can be moved to the refracted position either before or after the breaking operation. The extension and retraction timing can be varied, computer controlled, or both, to match the scoring process so substantially the entire length of the score is sufficiently flattened for successful scoring.

Optionally, the method can further include, for example, the step of waiting a predetermined amount of time after applying the force F to the extended portion 116 of the glass sheet 102, to stabilize the extended portion 116 before forming the score line. The “bow pop” behavior can take some time to occur, and thereafter it may take further time to dissipate the internal vibrations within the glass sheet 102. For example, turning briefly to FIG. 9, a graph 300 shows the results of an experiment measuring the position of the edge portion 104B relative to a fixed point on the apparatus 100. The x-axis 302 indicates numerous example glass sheets that were cut using the aforedescribed methodology, while the y-axis 304 indicates the measured distance of the edge portion 104B for each glass sheet. Line 306 shows a desired or predetermined distance of the edge portion 104B that results in a desirable score line on the glass. Three experimental groups are illustrated: group one 310 shows results without use of the manipulation device 140; group two 312 shows results using the manipulation device 140; and group three 314 shows results using the manipulation device 140 including the optional step of waiting a predetermined amount of time after applying the force F and before forming the score line.

The distance of the edge portion 104B among the group one 310 glass sheets was highly variable, which caused variable surface stress and undesirable vibrations in the surface of each sample glass sheet. The variable surface stress and vibrations ultimately resulted in a highly variable median crack among the sample glass sheets, resulting in sheet breakage and lower yields. The glass sheets of group two 312 showed a more consistent distance of the edge portion 104B that provided consistent surface stress and reduced vibrations in the surface of each sample glass sheet. However, the glass sheets of group three 314 exhibited an even more consistent distance of the edge portion 104B, providing even more consistent surface stress and greatly reduced vibrations in the sample glass sheets. The more consistent surface stress and reduced vibrations ultimately resulted in a highly consistent median crack among the sample glass sheets that provided clean and accurate glass severing and higher product yields.

Preferably, the method can be performed multiple times on numerous similar glass sheets 102 during a production run without having to re-adjust the various elements discussed herein. Still, it can be beneficial to adjust one or more of the settings of the apparatus 100 dynamically for each glass sheet 102 to be severed. For example, the method can optionally include the step of sensing a first orientation of the glass sheet 102 after the step of positioning the scoring device 114 against the first side 110 of the central portion 108 of the glass sheet 102. Various portions of the glass sheet 102 could be sensed. In one example, shown in FIG. 1, a sensor 180A could be used to sense the first orientation of the extended portion 116 of the glass sheet 102. In another example, shown in FIG. 3, a sensor 180B could be used to sense the first orientation of the glass sheet 102 located between the tower clamp 120 and the scoring device 114. Combinations of the sensors 180A, 180B in these or different locations could also be used. Various types of sensors 180A, 180B could be used, such as an ultrasonic sensor, an ultra-violet sensor, a laser ranging sensor, a linear variable differential transducer (LVDT) sensor, or combinations thereof. One or more sensors can be used, and multiple types of sensors could also be used together.

The method can further include, for example, the optional step of determining the amount of a force F to be applied to the extended portion 116 of the glass sheet 102 sufficient to achieve a predetermined severing orientation based, for example, upon a comparison of the sensed first orientation and the predetermined severing orientation. For example, the sensed first orientation can be similar to the predetermined severing orientation, requiring a relatively small amount of force F to be applied to the extended portion 116. Alternatively, the sensed first orientation can be relatively more divergent from the predetermined severing orientation, requiring a relatively larger amount of force F to be applied to the extended portion 116. The amount of force F can be dynamically determined and adjusted for each glass sheet 102. Optionally, the amount of force F can be dynamically determined and adjusted multiple times in an iterative fashion for each glass sheet 102. In addition or alternatively, the method can further include the optional step of determining the amount of a force F sufficient to achieve a predetermined surface stress along the first side 110 of the glass sheet 102 adjacent the scoring device 114.

Next, based on the determined amount of force, the method can include, for example, the step of applying the force F to the extended portion 116 of the glass sheet 102 to temporarily bend the extended portion 116 of the glass sheet 102 to achieve the predetermined severing orientation, surface stress, or both. Optionally, the method can further include, for example, the step of dynamically adjusting a location of the force F application on the extended portion 116 of the glass sheet 102 based upon the comparison of the sensed first orientation and the predetermined severing orientation. The glass sheet 102 may have internal stresses that cause the glass sheet to distort into a non-symmetric compound shape (e.g., a “potato chip” type shape) that can be corrected by leveraging the “bow pop” behavior across one or more axes. One or more manipulation devices 140 can be dynamically located to apply the force(s) F to accommodate the compound glass shape.

It is further contemplated that the aforedescribed dynamic adjustment method can also be applied to an initial glass sheet in a production run, with the determined settings of the apparatus 100 being used for multiple glass sheets in the production run. For example, the dynamic adjustment method can be used to partially or completely determine the settings of the apparatus 100 for the production run. In embodiments, the location, the amount of force F, or both, can be determined manually or automatically (e.g., by a computer control system) using various techniques, such as via algorithms, look-up tables, finite element analysis (FEA), previous experimental results, etc.

Conventional glass scoring practices in production on 1160×1680 FS size glass product on 0.3 mm thick glass produced about a 60% yield using a standard scoring wheel. Applying the methods and apparatus described herein has been shown to experimentally produce about a 90% yield on the same glass and scoring equipment, which is a significant improvement. The methods described herein can also provide some or all of the following advantages and benefits: reduces bead vibration while scoring by providing consistent stress field during scoring; stabilizes score vent depth; prevents premature bead score crack propagation; produces consistent and repeatable bow direction, magnitude and/or shape; reduces sheet breakage; reduces large and variable sheet shape; facilitates and optimizes sheet positioning for scoring; facilitates scoring of high vertical and horizontal bowed glass sheet; facilitates scoring glass with low sheet stiffness; facilitates scoring glass sheet while cooling is occurring and is heat resistant; facilitates scoring of rapidly changing glass sheet shape (dynamic shape) by directing the glass bow preferentially; the technology and methods can be easily applied across various glass sizes ranges and thicknesses; manipulation structure and methods can be utilized for both narrow and wide bead glass; manipulation structure and methods can be readily integrated into current production systems; installation is uncomplicated requiring minimal disruption to current production set-ups; external pneumatic control can be utilized; manipulation structure and methods are adjustable (e.g., depth, velocity, and/or hold position can be adjusted to fine tune to desire bead shape); manipulation structure and methods have narrow and wide bead capabilities; and prevents fracture during scoring even with variable incoming sheet shapes.

It will be apparent to those skilled in the art that various modifications and variations can be made to the present disclosure without departing from the scope of the invention. Thus, it is intended that the present invention cover the modifications and variations of this disclosure provided they come within the scope of the appended claims and their equivalents.

What is claimed is:

1. A method to manipulate a glass sheet compound shape during a severing operation, comprising:
positioning a scoring device against the first side of the central portion of the glass sheet, the glass sheet having a pair of opposed edge portions and a central portion laterally spanning between the opposed edge portions, and the central portion having a first side facing a first direction and a second side facing a second direction opposite the first direction;
temporarily bending an extended portion of the glass sheet located between the scoring device and a selected one of the edge portions from a first orientation to a severing orientation by applying a force to the extended portion of the glass sheet;
forming a score line along the first side of the central portion of the glass sheet while the force is being applied to the extended portion of the glass sheet; and
breaking away the selected one of the edge portions from the glass sheet along the score line.

2. The method of claim 1, wherein the extended portion of the glass sheet is temporarily bent in a direction toward the first side of the glass sheet.

3. The method of claim 1, wherein the force is applied to the extended portion of the glass sheet via an extendable element.

4. The method of claim 3, wherein the extendable element is configured to either push or pull against the second side of the glass to apply the force to the extended portion.

5. The method of claim 4, wherein a distal end of the extendable element comprises a suction cup geometry for applying the force to the second side of the glass.

6. The method of claim 3, wherein the extendable element is provided on a slide, and the method further comprises a step of adjusting a position of the extendable element along the slide to achieve the severing orientation of the glass sheet.

7. The method of claim 1, further comprising a step of positioning a side break assembly as a fulcrum against the first side of the central portion of the glass sheet at a location between the scoring device and the selected one of the edge portions.

8. The method of claim 1, further comprising a step of waiting a predetermined amount of time after applying the force to the extended portion of the glass sheet to stabilize the extended portion before forming the score line.

9. The method of claim 1, further comprising the steps of:
sensing the first orientation of the extended portion of the glass sheet; and
dynamically adjusting the amount of the force applied to the extended portion of the glass sheet based upon a comparison of the sensed first orientation and a predetermined severing orientation.

10. The method of claim 9, further comprising a step of dynamically adjusting a location of the force application on the extended portion of the glass sheet based upon a comparison of the sensed first orientation and the predetermined severing orientation.

11. A method to manipulate a glass sheet compound shape during a severing operation, comprising:
positioning a scoring device against the first side of the central portion of the glass sheet, the glass sheet having a pair of opposed edge portions and a central portion laterally spanning between the opposed edge portions, and the central portion having a first side facing a first direction and a second side facing a second direction opposite the first direction;
applying a force to an extended portion of the glass sheet located between the scoring device and a selected one of the edge portions sufficient to achieve a predetermined surface stress along the first side of the glass sheet adjacent the scoring device;
forming a score line along the first side of the central portion of the glass sheet while the force is being applied to the extended portion of the glass sheet; and
breaking away the selected one of the edge portions from the glass sheet along the score line.

12. The method of claim 11, wherein the predetermined surface stress is substantially constant along the first side of the glass sheet adjacent the scoring device.

13. The method of claim 11, wherein the extended portion of the glass sheet is temporarily bent in a direction toward the first side of the glass sheet.

14. The method of claim 11, wherein the force is applied to the extended portion of the glass sheet via an extendable element that is configured to either push or pull against the second side of the glass.

15. The method of claim 11, further comprising the steps of:
sensing a first orientation of the extended portion of the glass sheet; and
dynamically adjusting the amount of the force applied to the extended portion of the glass sheet based upon a comparison of the sensed first orientation and a predetermined severing orientation.

16. A method to manipulate a glass sheet compound shape during a severing operation, comprising:
positioning a scoring device against the first side of the central portion of the glass sheet, the glass sheet having a pair of opposed edge portions and a central portion laterally spanning between the opposed edge portions, and the central portion having a first side facing a first direction and a second side facing a second direction opposite the first direction;
sensing a first orientation of an extended portion of the glass sheet located between the scoring device and a selected one of the edge portions;
determining an amount of a force to be applied to the extended portion of the glass sheet sufficient to achieve a predetermined severing orientation based upon a comparison of the sensed first orientation and the predetermined severing orientation;
applying the force to the extended portion of the glass sheet to temporarily bend the extended portion of the glass sheet to achieve the predetermined severing orientation;
forming a score line along the first side of the central portion of the glass sheet while the force is being applied to the extended portion of the glass sheet; and
breaking away the selected one of the edge portions from the glass sheet along the score line.

17. The method of claim 16, wherein the predetermined severing orientation achieves a predetermined surface stress along the first side of the glass sheet adjacent the scoring device.

18. The method of claim 16, wherein the step of sensing the first orientation of the portion of the glass sheet is performed by at least one ultrasonic sensor.

19. The method of claim 16, further comprising a step of dynamically adjusting a location of the force application on the extended portion of the glass sheet based upon the comparison of the sensed first orientation and the predetermined severing orientation.

20. The method of claim 16, wherein the force is applied to the extended portion of the glass sheet via an extendable element that is configured to either push or pull against the second side of the glass.
